(19) United States
(12) Patent Application Publication
(10) Pub. No.: US 2022/0036439 A1
(43) Pub. Date: Feb. 3, 2022

(54) SYSTEM OF FOOD AND/OR BEVERAGE PREPARATION, COMMUNICATION APPLICATIONS AND/OR UNITS

(71) Applicant: ROUND APP LTD, Essex (GB)

(72) Inventor: Ethan Martin, Essex (GB)

(21) Appl. No.: 17/010,057

(22) Filed: Sep. 2, 2020

(30) Foreign Application Priority Data
Jul. 29, 2020 (GB) 2011789.1

(51) Int. Cl. G06Q 30/06; G06Q 50/12; H04W 4/021; H04W 88/08; H04W 88/16

(52) U.S. Cl. CPC G06Q 30/0643; G06Q 30/0629; H04W 88/16; H04W 4/021; H04W 88/085; G06Q 50/12

(57) ABSTRACT

A system of food and/or beverage preparation comprises a base station which is configured to down-link signals representative of items available for consumption from a venue, and a user interfacing network unit which is configured to display selectable options representative of food and/or beverage items and which is configured to allow a user to input selections from the items, the inputted selections being up-linked in the form of representative signals to the base station, the base station being further configured to communicate signals representative of the selections to a preparation station, wherein the base station comprises a filtration module which is configured to exclude a selection of down-link signals in response to a user input; whereby the down-link signals are reduced in accordance with the selection and thereby leading to a reduction of displayed selectable options.

### PRIORITY CLAIM

This application claims the benefit of the filing date of European Patent Application Ser. No. 2011789.1, filed Jul. 29, 2020.

### TECHNICAL FIELD

The present disclosure relates to systems of food and/or beverage preparation, communication applications and/or units.

### BACKGROUND

An example of prior art ordering stations is provided in US20050261974A which discloses a touch screen ordering system for fast food sales that includes a number of transaction language selection keys; a payment type selection key for allowing payment to be made via cash, charge, debit, check, etc.; a touch screen menu item display as well as offered menu item options display; an enter menu item selection; an enter additional menu item key; a running display showing total payment due as well as total items ordered; a submit order for preparation; an approximate order preparation time; and a total fee for the meal in question.

Since this early prior art, fast-food chains have been responding to the increasingly complex demands and queries of their customers by developing in restaurant self-standing ordering stations which are equipped with a stand through which wiring is provided to power a large touch sensitive screen of often over a meter in height and over half a meter in width. The touch screen displays simultaneously the potential menus on offer in the venue in question and allows the navigation to individual items in certain sub-menus where an interface allows users to configure the combination of ingredients for a chosen item. This provides each customer with the opportunity to input his specific requests not only at the item level but at the level of the ingredients which may constitute the selected item. A computer system records these inputs and transmits signals representative of these directly to screens located in close proximity to the cooking operatives who then manually follow the instructions on the screens to assemble the selected items. These stations located both at the user interface and at the cooking operative interface are particularly power hungry as they are constantly switched on and ready for interaction and viewing as appropriate. The number of potential ordering options given the large choice of items and the ability to customize the ingredients to be incorporated in these items has generated a mathematically complex result. The number of potential resulting differing orders are astonishingly several order of magnitudes from what would have been contemplated as practical in fast-food chains in 2005. These systems have been widely rolled out in many fast-food chains to provide millions of different food choices. These systems are restaurant or chain specific, and require large infrastructure investments in each. Whilst customer choice has been dramatically enhanced so has the power consumption required to offer these complex choices and the computer power required to process them. Bearing in mind, that these systems have been rolled out extensively, these negative environmental impacts have been further amplified with the primary benefit of providing improved customer choice. Certain embodiments of the present disclosure seek to provide an alternative structure without the same negative environmental impact whilst not only maintaining the ability to handle these complexities of choice but to add further technical advantages allowing these systems to cope with even greater complexity.

### BRIEF SUMMARY

In a first broad independent aspect, the present disclosure provides a system of food and/or beverage preparation comprising a base station which is configured to down-link signals representative of items available for consumption from a venue, and a user interfacing network unit which is configured to display selectable options representative of food and/or beverage items and which is configured to allow a user to input selections from the items, the inputted selections being up-linked in the form of representative signals to the base station, the base station being further configured to communicate signals representative of the selections to a preparation station, wherein the base station comprises a filtration module which is configured to exclude a selection of down-link signals in response to a user input; whereby the down-link signals are reduced in accordance with the selection and thereby leading to a reduction of displayed selectable options.

This configuration is particularly advantageous as it reverses conventional thinking in the art by providing complex selections to a user without requiring large touch screen displays of the kind currently being used. Embodiments of the present disclosure are envisaged to be able to reduce the power consumption by a factor at least proportional with the potential screen size reduction. The present disclosure lends itself to an incorporation in certain embodiments into vehicles as they may use existing relatively small-scale screen sizes already present in these. The present disclosure will have particular advantages in self-driving vehicles as the vehicle's displacement may be configured to arrive just in time for the collection of the prepared food and/or beverage, thus, in certain embodiments, avoiding the requirement of a vehicle idling during the preparation time. In that context, an embodiment envisages the correlation of the vehicle arrival time with the estimated meal completion time.

In a subsidiary aspect, the user interfacing network unit comprises a communication application configured to communicate with a plurality of network addresses of a corresponding plurality of base stations of food and/or beverage preparation, the application providing a user interface capable of being displayed on a display of a user interfacing network unit and containing user-selectable items corresponding to each of the plurality of base stations, the user interfacing network unit being configured to determine and selectively communicate its spatial coordinates, the base stations having spatial coordinates which are discoverable by the user interfacing network unit, and a module which is configured to rank the base stations in terms of their proximity to the user interfacing network unit; the application providing the user with the option of selecting any one more of the base stations to download signals corresponding solely to the selected base station.

This configuration is also particularly advantageous because it allows a system which may be employed by a plurality of disparate and commercially separate base stations whilst potentially avoiding the requirement to download base station specific applications which may be particularly difficult to interact with as they are not formed in an identical pattern as the user interface of one application varies significantly from one application to the other. This ranking also allows for the efficient identification of venues which will more accurately be determined as suitable for particular users.

In a further subsidiary aspect, each base station comprises a database of items and the communication applications configured display items in a plurality of different fonts and/or color schemes dependent upon the selected base station. This configuration advantageously combines sufficient homogeneous configurations for efficient user interaction whilst at the same time providing sufficient brand distinction as may be required by the operators of the food and/or beverage establishments.

In a further subsidiary aspect, the communication application is configured to facilitate the interrogation of a remote database of criteria. This efficiently provides remote large capacity storage facilities whilst minimizing, in certain embodiments, the requirements and the volume of signals for down-linking.

In a further subsidiary aspect, the criteria includes a quantity of calories per item and the system comprises a module for adding up the calories dependent upon the selection of items. This configuration is particularly advantageous as it allows enhanced customization of the order in order to meet complex dietary requirements which may be tailored to the user of the unit.

In a subsidiary aspect, the communication application is configured to set a target amount of calories and to provide a comparison between the calories for the selection of items and the target amount of calories. This allows for even more precise selection of appropriate foods and beverages to suit increasingly complex customer requirements.

In a subsidiary aspect, the communication application includes an option for displaying only a particular sub-category of items. This would allow, for example, only vegan options to be downloaded from the base station which would provide more precise search results for a user whilst at the same time providing an efficient use of the network.

In a subsidiary aspect, the communication application is configured to send signals representative of individual ingredients selected from a list. This would allow a user to specify individual ingredients which must be present, such as ice or lemon, in addition to providing the option of specifically excluding certain ingredients.

In a further subsidiary aspect, the user interfacing network unit is configured to poll the base station to obtain an indication as to the preparation time of a selected item; the preparation time being calculated dependent upon the number of items being simultaneously prepared. This would provide feedback in real time to a user in order to optimize the time of collection of an order.

In a further subsidiary aspect, the user interfacing network unit is configured to power-off after a user selectable time period elapses. This configuration allows not only the unit to economies on its consumption but to do so differentially dependent on individual users and their requirements for the user interfacing network unit.

In a further subsidiary aspect, the base station incorporates a signal repeater. This is particularly important in large ordering venues as the ordering position may be remote from the collection point.

In a further subsidiary aspect, the base station incorporates a signal amplifier. This would also be particularly advantageous in reaching areas in particularly congested or built-up areas in order to allow the user not only to optimize the preparation time but do so without necessarily employing external satellite communication means.

In a subsidiary aspect, the system comprises a base station and a repeater configured to communicate with a plurality of user interfacing network units. This allows large volumes of interaction to take place simultaneously in order to avoid the conventional need for queuing.

In a further subsidiary aspect, the base station is provided remotely from both the preparation station and the user interfacing network unit. This allows the food preparation area to be remote yet in certain embodiments able to respond in real time to orders.

In a subsidiary aspect, the preparation station and the base station are formed as a single unit comprising a communication module and a display screen. This configuration is particularly compact which may be advantageous for relatively small-scale venues.

In a further subsidiary aspect, a plurality of preparation stations are envisaged and are segregated from one another. In this context, a first preparation station handles only a first selection of ingredients whilst at least one second preparation station handles only a second selection of ingredients. This ensures in most embodiments that no cross-contamination of ingredients between orders would arise. This deals advantageously with the increasing demands on providers to ensure that the food has been prepared with no cross-contamination of excluded ingredients.

In a subsidiary aspect, the first preparation station is provided in a first enclosure, and the second preparation station is provided in a second enclosure. This provides for complete separation of ingredients to minimize any risk of cross-contamination in the preparation of food and/or beverage.

In a subsidiary aspect, the communication application provides the option of selecting a delivery of food/beverage produce to the discoverable spatial coordinates of the user interfacing network unit and a validation step allowing a user to enter an additional specific pre-determined geographic area in the vicinity of the user interfacing network unit to which the food/beverage is to be delivered. This configuration allows for an even more precise delivery of food and/or beverage whilst minimizing the complexity of the interaction between the user and the system.

In a further independent aspect, the present disclosure provides a system of food and/or beverage preparation comprising a base station which is configured to down-link signals representative of items available for consumption from a venue, and a user interfacing network unit, which is configured to display selectable options representative of food and/or beverage items and which is configured to allow a user to input selections from the items, the inputted selections being up-linked in the form of representative signals to the base station, the base station being further configured to communicate signals representative of the selections to a preparation station, wherein the user interfacing network unit comprises a communication application configured to communicate with a plurality of network addresses of a corresponding plurality of base stations of food and/or beverage preparation, the application providing a user interface capable of being displayed on a display of a user interfacing network unit and containing user-selectable items corresponding to each of the plurality of base stations, the user interfacing network unit being configured to determine and selectively communicate its spatial coordinates, the base unit having spatial coordinates which are discoverable by the user interfacing network unit, a module which is configured to rank the base stations in terms of their proximity to the user interfacing network unit; the application providing the user with the option to select any one or more of the base stations to download signals corresponding solely to the selected base station. This allows for a system for preparation of food and beverage which may be universally adopted whilst at the same time providing targeted results which may be relevant to a user with a relatively small screen. This additional configuration would significantly reduce the necessary power consumption, as compared to the very large screens employed in the prior art.

In a subsidiary aspect, each base station comprises a database of items and the communication application is configured to display items in a plurality of different fonts and/or color schemes dependent upon the selected base station. This allows a system to be universally applicable whilst at the same time providing sufficient distinction between separately owned base stations.

In a subsidiary aspect, the communication application is configured to facilitate the interrogation of a remote database of criteria.

In a subsidiary aspect, the criteria include a quantity of calories per item and the system comprises a module for adding up the calories dependent upon the selection of items.

In a subsidiary aspect, the communication application is configured to set a target amount of calories and to provide a comparison between the calories for the selection of items and the target amount of calories.

In a subsidiary aspect, the communication application includes an option for displaying only a particular sub-category of items.

In a subsidiary aspect, the communication application is configured to send signals representative of individual ingredients selected from a list.

In a further subsidiary aspect, the user interfacing network unit is configured to poll the base station to obtain an indication as to the preparation time of a selected item; the preparation time being calculated dependent upon the number of items being simultaneously prepared.

In a subsidiary aspect, the user interfacing network is configured to power-off after a user-selectable time period elapses.

Preferably, the base station incorporates a signal repeater.

Further preferably, the base station incorporates a signal amplifier.

Further preferably, the system comprises a base station and a repeater configured to communicate with a plurality of user interfacing network units.

In a further subsidiary aspect, the base station is provided remotely from both the preparation station and the user interfacing network unit.

In a further subsidiary aspect, the preparation station and the base station are formed as a single unit comprising a communication module and a display screen.

Preferably, the system comprises a plurality of preparation stations which are segregated from one another; whereby a first preparation station handles only a first selection of ingredients whilst at least one second preparation station handles only a second selection of ingredients.

Preferably, the first preparation station is provided in a first enclosure, the second preparation station is provided in a second enclosure.

In a subsidiary aspect, the communication application provides the option of selecting a delivery of food/beverage produce to the discoverable spatial coordinates of the user interfacing network device and a validation step allowing a user to enter an additional specific pre-determined geographic area in the vicinity of the user interfacing network unit to which the food/beverage produce is to be delivered.

### BRIEF DESCRIPTION OF THE DRAWINGS

FIG. 1 shows a schematic overview of a system for the preparation of food/beverage in accordance with a first example.

FIG. 2 shows a flow diagram of the interaction of a user interfacing network unit with a plurality of disparate suppliers' APIs and preparation stations.

FIG. 3 shows a further example of the system in a schematic flow chart.

FIG. 4 shows an example of a display screen of a user interfacing network unit in accordance with an example.

FIG. 5 shows the display screen of a user network unit in accordance with a further configuration.

FIG. 6 shows a display screen in accordance with a further configuration.

FIG. 7 shows a display screen in accordance with a further configuration.

FIG. 8 shows a display screen in accordance with a further configuration.

FIG. 9 shows a display screen in accordance with a further configuration.

### DETAILED DESCRIPTION

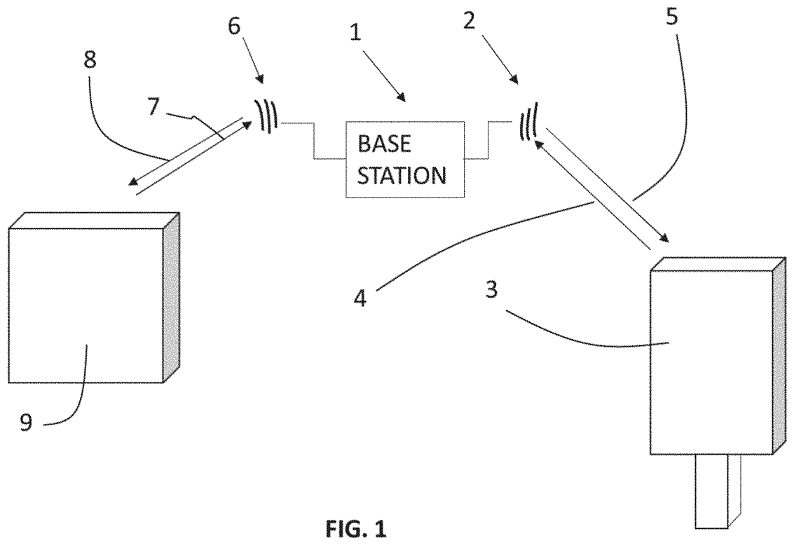

FIG. 1 shows a base station 1 of the kind which may be provided in a chain of fast-food restaurants which is equipped with a bi-directional communications interface 2 which may for example comprise an antenna for receiving up-link signals 4 from a user interfacing network unit which may take the form of a self-standing fixed user interfacing station 3 or a mobile station (not shown) in the form of a tablet, mobile phone, vehicle and any other such device. Similarly, the base station may send out down-link signals 5 to the user interfacing network unit. The system of communication between the base station and the mobile station is configured to selectively send down-link signals dependent upon user specific up-link signals. A filtration module is employed to achieve this enhanced functionality. For example, the user interfacing network unit provides the user with a plurality of options to select from in accordance with the dietary requirements of a user. A common dietary requirements might be for the avoidance of a particular ingredient such as nuts, cheese etc. By selecting the appropriate option or inputting the appropriate condition, the user interfacing network unit then communicates to the base station that only items without certain ingredients X, Y, Z etc. are contained in down-link signals to the user interfacing network unit. This provides a significant reduction in the signals in the down-link signals 5 which allows for a significant reduction in the required size of screen for the finalization of the user's choice. A further bi-directional communications interface 6 may comprise an antenna through which up-link signals 7 and down-link signals 8 are provided between the base station and a preparation station 9. The base station and the preparation station may be assigned IP addresses and may take the form of a server or other network node as appropriate.

The preparation station may comprise a display screen which may display instructions for preparing food and beverage. Alternatively, the preparation station may incorporate actuators which are controlled to assemble a particular item for preparation. These actuators may have 2D or 3D ranges of movement in order to pick and place individual items according to pre-determined movements.

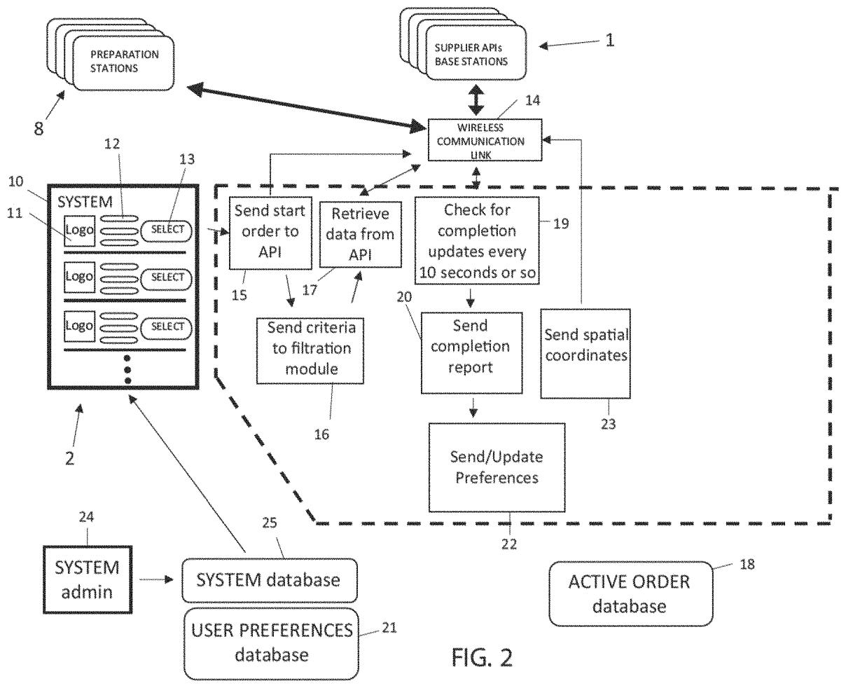

FIG. 2 shows in overview the protocols of interaction between base stations, preparation stations and the user-interfacing network units. The user-interfacing network unit may be graphically represented at reference numeral 10. In one mode of use, it may display a list of available venues. The available venues may be shown with their well-known logo as in box 11 alongside key characteristics in a list 12. An interactive button 13 defines a field on a touch screen which may be selected by a user. Following the touching of the touch-sensitive area of the touch screen, the communication application is configured to send signals via a wireless communication link 14 to the selected supplier's API or appropriate base stations. The signal may in effect signal the start of an order to the API as shown in box 15. In a subsequent phase of the communication protocol, the system is configured to send user inputted criteria to a filtration module as per box 16. It is on the basis of the criteria sent to the filtration module 16 that the system retrieves data from the API 17. The data retrieved from the API is only a relevant selection of the available data allowing users to more rapidly identify suitable choices to order. Once a selection is completed, the order is added to an active order database 18. The communication application is further equipped with appropriate processing means which send signals via the wireless communication link to one or both of the base stations and the preparation stations in order to seek updated information on the progress towards completion of the order. The frequency of this polling feature may be set to a pre-determined interval of time such as 10 seconds or so. This configuration of regularly checking for the completion of the preparation may be driven by a module 19. Upon completion, a completion report may be sent as per box 20. A user preferences database 21 may be provided to maintain a record of the preferences of a user in order to priorities the kind of criteria presented in future interactions with the user interfacing network unit. In addition, the system may be equipped with a module for sending and/or updating preferences which may be independent from past criteria selections. This may take the form of a module as shown in box 22. Furthermore, the communication application may be configured to send spatial coordinates via the wireless communication link to the supplier APIs. The spatial coordinate module 23 may also be configured to interrogate the spatial coordinates of other stations and will be employed in determining the potential ranking of the display on the user interfacing network unit 10. Separately from the other components of the system, an administration module 24 is envisaged in order to allow the operator to add and/or remove certain functionalities of the communication application. In addition, a system database 25 is provided, which may comprise the user preferences database. Appropriate security mechanisms are envisaged in order to protect the identity of particular users and their corresponding preferences.

Whilst a user interacts with potentially multiple APIs from commercially separate suppliers, the system doesn't require the downloading of entire specific supplier only applications which also not only saves on the download requirements but on the storage required on the user interfacing network units.

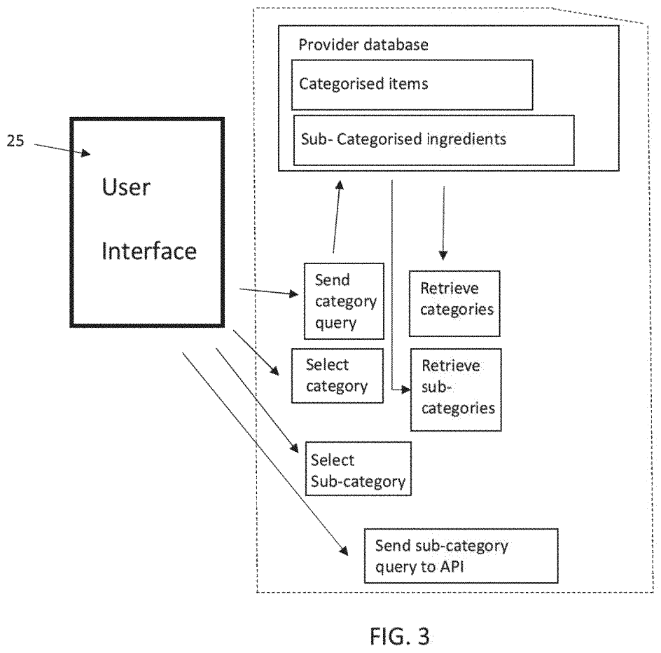

FIG. 3 shows further details of the user interface which may be provided as part of a user interfacing network unit. The user interface may be configured to send a category query to a provider's database. It may thereafter allow the selection of a particular category. In addition, the system may be configured to allow the selection of a sub-category and thereafter to initiate the sending of a sub-category query to the API. Therefore, the system selectively retrieves categories and sub-categories which have increased relevance to the user.

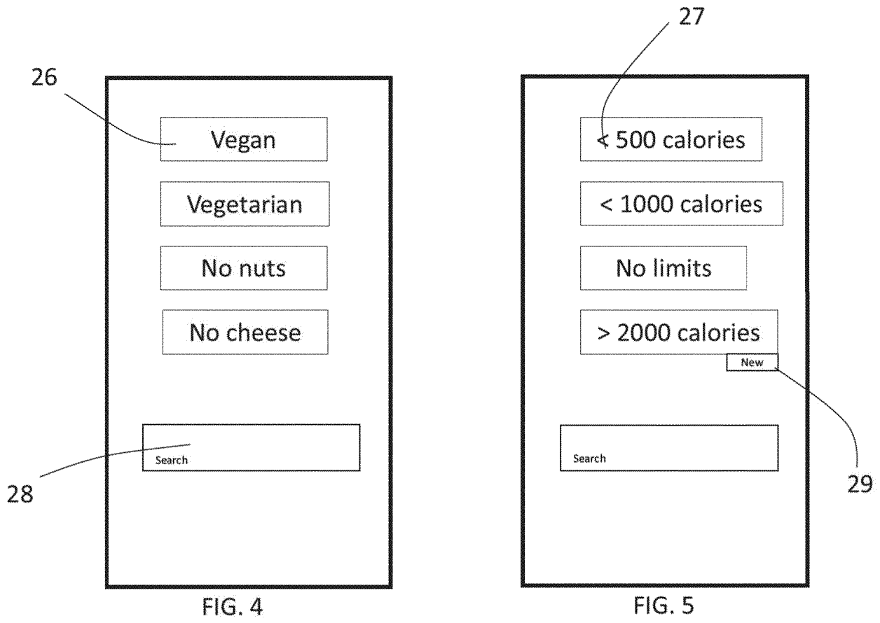

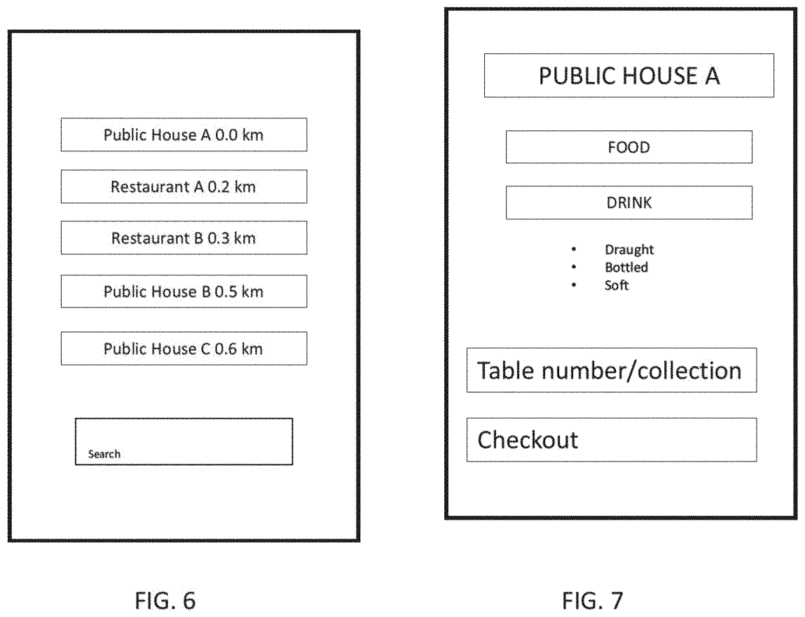

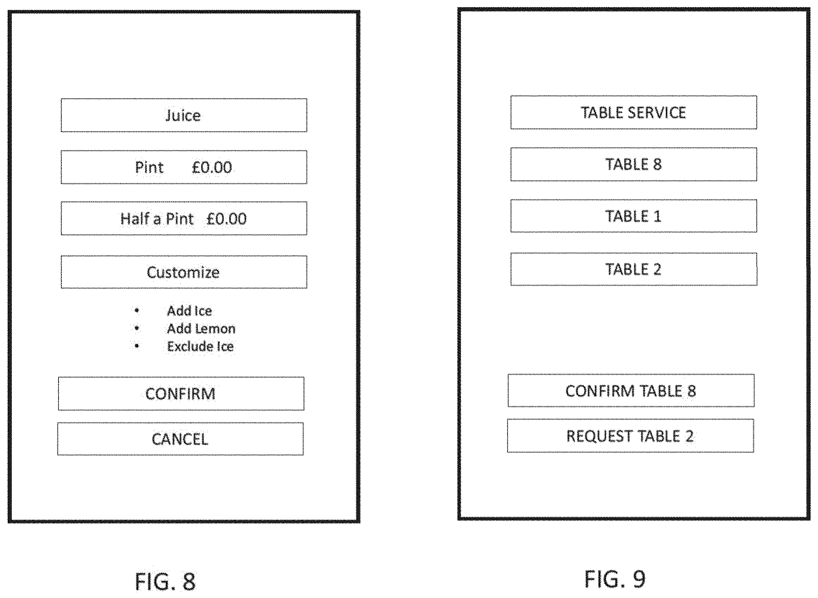

FIG. 4 shows an example of a display of the user interfacing network unit, which is configured to display a list of potential categories, such as vegan and vegetarian. It may also present specific exclusion criteria such as no nuts and no cheese. A search box 28 may also be provided to assist in the navigation of the API database. Upon selection of the criteria “vegan” the selected criteria is sent to the filtration module, which causes a reduced set of down-linked data to be communicated to the user interfacing network unit. Furthermore, by selecting the criteria “no nuts,” the API will only facilitate the information for the options, which are guaranteed to have “no nuts” thus providing a set of results, which is more straightforward to assess by a user and much more relevant than would otherwise be the case in an increasingly complex user interfacing network unit as detailed in the background section of the application.

In addition, as shown in FIG. 5, a module may be provided, which provides results based on individual calories and/or the addition of the calories in a particular menu of items. This would allow the user to select his menu solely on the basis of desired calorie quantities. The administrator may select further criteria to be available as the communication application is appropriately updated. In this case, when a new category is available which may also be accompanied by a flag to highlight the fact that the category is new in this instance as shown with button 29 in the display of FIG. 5. An aggregator may be provided to operate in conjunction with the base station which adds up the pre-determined calorie quantities for selected items to provide a single total figure for a particular order and/or menu within the order. The aggregator may seek to find further results based on multiple categories such as “no nuts” and “no cheese” with a total calorie count of fewer than 500. This configuration allows the user in effect to compose the equation for the search criteria in order to derive a complex and optimum solution to his search criteria.

As previously described, the user interfacing network unit may be equipped with a touch screen display which may present a list of venues in proximity to the unit which may be ranked in terms the closest venue to the furthest away. In this instance, public house A is at 0.0 km, restaurant A is located 0.2 km away, restaurant B is found 0.3 km away, public house B is located 0.5 km from the unit, and public house C is 0.6 km from the unit. The unit may preferably incorporate an option for its spatial coordinates to be discoverable by the communication application which will then be communicated through the system in order to provide the closest venues based on their own geo-spatial coordinates. A user may select one of the listed options which will then send a query to the API for information based on the venue as appropriate. The system may provide a venue-specific interface which may follow an application-specific format in terms of general layout but which may be configured for each API in order to preserve the font and colors which may have become distinctive for the brand in question. As shown in FIG. 7, the options for public house A may be one of food or drink with appropriate selectable sub-categories. In addition, options for delivery or service to a particular location, such as a table number, are envisaged as well as the option of collecting the food and/or beverage. A check-out option is provided as is conventional with many ordering applications. The system may employ in addition to the option of an input of a table number for setting up a table service, the system may determine based on spatial coordinates which table may be the one selected by the user. The suggested table number may be determined due to a bespoke triangulation between the network unit, the base station and the preparation station.

As detailed previously, the user may tap the product such as juice which it may be interested in ordering. In combination with this option, the user may initiate a customization module in which specific ingredients are added. In addition, specific ingredients may be excluded. If one for example wishes to exclude ice, this would also be an option by appropriately selecting the ingredient in question.

FIG. 9 also illustrates the table service module, which provides a ranking of potential tables which are not necessarily based on a numerical configuration but which may have been determined due to additional triangulation based upon the positioning of the unit relative to the base station and/or the preparation station. In this instance, table 8 has been identified as the likely location of the user by placing a particular order, the system therefore allows the user to confirm either that it is table 8 or to request an alternative table by inputting the appropriate table number as in this example “table 2.” In addition to the technological aspects described in detail, the brand owners may wish to provide detailed and bespoke nutritional information and ingredients to allow users to see exactly what is in the products they may wish to order. In this instance, a database of nutritional information may also be provided and information from this database may be down-linked in response to a specific query selected by the user. This may include allergen information, ingredients and other nutritional information.

In addition, a database of venues may also be provided which may each be identifiable by specific spatial coordinates. Users may also be able to search for venues by name. In addition, users may be able to search for particular menus by name and ingredients as opposed to venues and thereafter navigate to a particular venue.

In addition, the communication application may also be able to obtain interactive map information allowing users to seek out new venues via the application. A filter may also be provided in combination with the map module in order to allow the user to input specific further criteria, such as disabled accessibility, vegan-friendly, average price, average rating, dog-friendly, etc. Furthermore, a user profile database may be maintained in conjunction with the ability to upload personal preferences in order to instantly filter menus, including allergen information, eating preferences (for example vegetarian, vegan, gluten-free, nut allergies, etc.). Due to the specific structure of the communication application, it is envisaged that the users with specific eating preferences will also be increasingly confident in using the application. The providers will also be able to more efficiently structure a preparation area by appropriately segregating specific allergy-free preparation areas. For example, a first enclosure may be provided for a nut-free preparation area, whilst a second enclosure may be employed for the preparation of any other type of items.

The communication application may be configured dependent upon the requirements of the API or base stations in order to provide appropriate color schemes for specific brands taking into account for example background color, main text color, subtext color and highlight color. Logos as previously described are also envisaged as part of the display.

The user interface may also be in a variety of potential languages and may facilitate the instant menu translation in order to remove potential language barriers between venues and customers.

What is claimed is:

1. A system of food and/or beverage preparation comprising a base station which is configured to down-link signals representative of items available for consumption from a venue, and a user interfacing network unit which is configured to display selectable options representative of food and/or beverage items and which is configured to allow a user to input selections from the items, the inputted selections being up-linked in the form of representative signals to the base station, the base station being further configured to communicate signals representative of the selections to a preparation station, wherein the base station comprises a filtration module which is configured to exclude a selection of down-link signals in response to a user input; whereby the down-link signals are reduced in accordance with the selection and thereby leading to a reduction of displayed selectable options.

2. The system of claim 1, wherein the user interfacing network unit comprises a communication application configured to communicate with a plurality of network addresses of a corresponding plurality of base stations of food and/or beverage preparation, the application providing a user interface capable of being displayed on a display of a user interfacing network unit and containing user-selectable items corresponding to each of the plurality of base stations, the user interfacing network unit being configured to determine and selectively communicate its spatial coordinates, the base stations having spatial coordinates which are discoverable by the user interfacing network unit, and a module which is configured to rank the base stations in terms of their proximity to the user interfacing network unit; the application providing the user with the option to select any one or more of the base stations to download signals corresponding solely to the selected base station.

3. The system of claim 2, wherein each base station comprises a database of items and the communication application is configured to display items in a plurality of different fonts and/or color schemes dependent upon the selected base station.

4. The system of claim 2, wherein the communication application is configured to facilitate interrogation of a remote database of criteria.

5. The system of claim 4, wherein the criteria includes a quantity of calories per item and the system comprises a module for adding up the calories dependent upon the selection of items.

6. The system of claim 5, wherein the communication application is configured to set a target amount of calories and providing a comparison between the calories for the selection of items and the target amount of calories.

7. The system of claim 2, wherein the communication application includes an option for displaying only a particular sub-category of items.

8. The system of claim 2, wherein the communication application is configured to send signals representative of individual ingredients selected from a list.

9. The system of claim 1, wherein the user interfacing network unit is configured to poll the base station to obtain an indication as to a preparation time of a selected item; the preparation time being calculated dependent upon the number of items being simultaneously prepared.

10. The system of claim 1, wherein the user interfacing network unit is configured to power-off after a user selectable time period elapses.

11. The system of claim 1, wherein the base station incorporates a signal repeater.

12. The system of claim 1, wherein the base station incorporates a signal amplifier.

13. The system of claim 1, wherein the system comprises a base station and a repeater configured to communicate with a plurality of user interfacing network units.

14. The system of claim 1, wherein the base station is provided remotely from both the preparation station and the user interfacing network unit.

15. The system of claim 1, wherein the preparation station and the base station are formed as a single unit comprising a communication module and a display screen.

16. The system of claim 1, comprising a plurality of preparation stations which are segregated from one another; whereby a first preparation station handles only a first selection of ingredients whilst at least one second preparation station handles only a second selection of ingredients.

17. The system of claim 16, wherein the first preparation station is provided in a first enclosure and the second preparation station is provided in a second enclosure.

18. The system of claim 2, wherein the communication application provides the option of selecting a delivery of food/beverage produce to the discoverable spatial coordinates of the user interfacing network unit and a validation step allowing a user to enter an additional specific pre-determined geographic area in the vicinity of the user interfacing network unit to which the food/beverage is to be delivered.

19. A system of food and/or beverage preparation comprising a base station which is configured to down-link signals representative of items available for consumption from a venue, and a user interfacing network unit which is configured to display selectable options representative of food and/or beverage items and which is configured to allow a user to input selections from the items, the inputted selections being up-linked in a form of representative signals to the base station, the base station being further configured to communicate signals representative of the selections to a preparation station, wherein the user interfacing network unit comprises a communication application configured to communicate with a plurality of network addresses of a corresponding plurality of base stations of food and/or beverage preparation, the application providing a user interface capable of being displayed on a display of a user interfacing network unit and containing user-selectable items corresponding to each of the plurality of base stations, the user interfacing network unit being configured to determine and selectively communicate its spatial coordinates, the base stations having spatial coordinates which are discoverable by the user interfacing network unit, and a module which is configured to rank the base stations in terms of their proximity to the user interfacing network unit; the application providing the user with the option to select a base station to download signals corresponding solely to the selected base station.

20. The system of claim 19, wherein a base station comprises a database of items and the communication application is configured to display items in a plurality of different fonts and/or color schemes dependent upon the selected base station.

21. The system of claim 19, wherein the communication application is configured to facilitate an interrogation of a remote database of criteria.

22. The system of claim 21, wherein the criteria includes a quantity of calories per item and the system comprises a module for adding up the calories dependent upon the selection of items.

23. The system of claim 22, wherein the communication application is configured to set a target amount of calories and providing a comparison between the calories for the selection of items and the target amount of calories.

24. The system of claim 19, wherein the communication application includes an option for displaying only a particular sub-category of items.

25. The system of claim 19, wherein the communication application is configured to send signals representative of individual ingredients selected from a list.

26. The system of claim 19, wherein the user interfacing network unit is configured to poll the base station to obtain an indication as to a preparation time of a selected item; the preparation time being calculated dependent upon the number of items being simultaneously prepared.

27. The system of claim 19, wherein the user interfacing network unit is configured to power-off after a user selectable time period elapses.

28. The system of claim 19, wherein the base station incorporates a signal repeater.

29. The system of claim 19, wherein the base station incorporates a signal amplifier.

30. The system of claim 19, wherein the system comprises a base station and a repeater configured to communicate with a plurality of user interfacing network units.

31. The system of claim 19, wherein the base station is provided remotely from both the preparation station and the user interfacing network unit.

32. The system of claim 19, wherein the preparation station and the base station are formed as a single unit comprising a communication module and a display screen.

33. The system of claim 19, comprising a plurality of preparation stations which are segregated from one another; whereby a first preparation station handles only a first selection of ingredients whilst at least one second preparation station handles only a second selection of ingredients.

34. The system of claim 33, wherein the first preparation station is provided in a first enclosure and the second preparation station is provided in a second enclosure.

35. The system of claim 19, wherein the communication application provides the option of selecting a delivery of food/beverage produce to the discoverable spatial coordinates of the user interfacing network device and a validation step allowing a user to enter an additional specific pre-determined geographic area in a vicinity of the user interfacing network unit to which the food/beverage produce is to be delivered.
